(19) United States
(12) Patent Application Publication
(10) Pub. No.: US 2024/0153041 A1
(43) Pub. Date: May 9, 2024

(54) IMAGE PROCESSING METHOD AND APPARATUS, COMPUTER, READABLE STORAGE MEDIUM, AND PROGRAM PRODUCT

(71) Applicant: Tencent Technology (Shenzhen) Company Limited, Shenzhen (CN)

(72) Inventors: Keke HE, Shenzhen (CN); Junwei ZHU, Shenzhen (CN); Wenqing CHU, Shenzhen (CN); Ying TAI, Shenzhen (CN); Chengjie WANG, Shenzhen (CN)

(21) Appl. No.: 18/417,916

(22) Filed: Jan. 19, 2024

Related U.S. Application Data
(63) Continuation of application No. PCT/CN2023/111212, filed on Aug. 4, 2023.

(30) Foreign Application Priority Data
Aug. 12, 2022 (CN) 202210967272.3

(51) Int. Cl. G06T 5/50; G06T 3/4053; G06V 10/25

(52) U.S. Cl. CPC G06T 5/50; G06T 3/4053; G06V 10/25; G06T 2207/20221; G06V 2201/07

(57) ABSTRACT

This application discloses a method for generating an image processing model performed by a computer device. The method includes: performing training by using a first source image sample, a first template image sample, and a first standard synthesized image, to obtain a first parameter adjustment model, and combining the first parameter adjustment model and a first resolution update layer into a first update model; adjusting the first update model into a second parameter adjustment model using a second source image sample and a second template image sample and a second standard synthesized image; combining the second parameter adjustment model and a second resolution update layer into a second update model; and adjusting the second update model into a target image fusion model using a third source image sample, a third template image sample and a third standard synthesized image.

### CROSS-REFERENCE TO RELATED APPLICATIONS

This application is a continuation application of PCT Patent Application No. PCT/CN2023/111212, entitled “IMAGE PROCESSING METHOD AND APPARATUS, COMPUTER, READABLE STORAGE MEDIUM, AND PROGRAM PRODUCT” filed on Aug. 4, 2023, which claims priority to Chinese Patent Application No. 202210967272.3, entitled “IMAGE PROCESSING METHOD AND APPARATUS, COMPUTER, READABLE STORAGE MEDIUM, AND PROGRAM PRODUCT” and filed with the China National Intellectual Property Administration on Aug. 12, 2022, all of which is incorporated herein by reference in its entirety.

### FIELD OF THE TECHNOLOGY

This application relates to the field of computer technologies, and in particular, to an image processing method and apparatus, a computer, a readable storage medium, and a program product.

### BACKGROUND OF THE DISCLOSURE

Currently, video face swapping has many application scenarios, such as film and television portrait production, game character design, avatar, privacy protection, and the like. For example, in film and television production, there are some professional shots that cannot be completed by ordinary people, and therefore, the professional shots need to be completed by professionals, and film and television production may be implemented later through the face swapping technology; or in a video service (such as livestreaming or a video call, and the like), a virtual character may be used to perform a face swapping operation on a video image of a user, to obtain a virtual image of the user, and perform the video service through the virtual image. In the current face swapping method, generally a face swapping algorithm with a resolution of 256 is used to perform face swapping processing. An image generated by the face swapping algorithm is relatively blurry, but now a requirement for clarity of a video, an image, and the like is getting increasingly high. However, an image after face swapping is performed has low clarity and a poor display effect.

### SUMMARY

Embodiments of this application provide an image processing method and apparatus, a computer, a readable storage medium, and a program product, to improve clarity and a display effect of a processed image.

According to an aspect, embodiments of this application provide a method for generating an image processing model, including:
performing parameter adjustment on an initial image fusion model by using a first source image sample, a first template image sample, and a first standard synthesized image to obtain a first parameter adjustment model, and inserting a first resolution update layer into the first parameter adjustment model, to obtain a first update model;
performing parameter adjustment on the first update model by using a second source image sample and a second template image sample, and a second standard synthesized image, to obtain a second parameter adjustment model;
inserting a second resolution update layer into the second parameter adjustment model, to obtain a second update model; and
performing parameter adjustment on the second update model by using a third source image sample and a third template image sample, and a third standard synthesized image, to obtain a target image fusion model configured to fuse an object in one image into another image.

According to an aspect, embodiments of this application provide an image processing method, including:
obtaining a source image and a template image, inputting the source image and the template image into a target image fusion model, and fusing the source image and the template image through the target image fusion model, to obtain a target synthesized image; the target image fusion model being obtained by performing parameter adjustment on a second update model by using a third source image sample, a third template image sample, and a third standard synthesized image, a resolution of the third source image sample and the third template image sample being a fourth resolution, and a resolution of the third standard synthesized image being a fifth resolution; the second update model being obtained by inserting a second resolution update layer into a second parameter adjustment model; the second parameter adjustment model being obtained by performing parameter adjustment on a first update model by using a second source image sample, a second template image sample, and a second standard synthesized image, a resolution of the second source image sample and the second template image sample being a second resolution, and a resolution of the second standard synthesized image being a third resolution; the first update model being obtained by inserting a first resolution update layer into a first parameter adjustment model; and the first parameter adjustment model being obtained by performing parameter adjustment on an initial image fusion model by using a first source image sample, a first template image sample, and a first standard synthesized image, and a resolution of the first source image sample, the first template image sample, and the first standard synthesized image being a first resolution.

According to an aspect, embodiments of this application further provides an image processing apparatus, including:
a first sample obtaining module, configured to obtain a first source image sample, a first template image sample, and a first standard synthesized image at a first resolution;
a first parameter adjustment module, configured to perform parameter adjustment on an initial image fusion model by using the first source image sample, the first template image sample, and the first standard synthesized image, to obtain a first parameter adjustment model;
a first model update module, configured to insert a first resolution update layer into the first parameter adjustment model, to obtain a first update model;
a second sample obtaining module, configured to obtain a second source image sample and a second template image sample at a second resolution, and obtain a second standard synthesized image at a third resolution;
a second parameter adjustment module, configured to perform parameter adjustment on the first update model by using the second source image sample, the second template image sample, and the second standard synthesized image, to obtain a second parameter adjustment model; the second resolution being greater than or equal to the first resolution, and the third resolution being greater than the first resolution;
a second model update module, configured to insert a second resolution update layer into the second parameter adjustment model, to obtain a second update model;
a third sample obtaining module, configured to obtain a third source image sample and a third template image sample at a fourth resolution, and obtain a third standard synthesized image at a fifth resolution; and
a third parameter adjustment module, configured to perform parameter adjustment on the second update model by using the third source image sample, the third template image sample, and the third standard synthesized image, to obtain a target image fusion model; the target image fusion model being configured to fuse an object in one image into another image; and the fourth resolution being greater than or equal to the third resolution, and the fifth resolution being greater than or equal to the fourth resolution.

According to an aspect, embodiments of this application further provides an image processing apparatus, including:
an image obtaining module, configured to obtain a source image and a template image;
an image synthesizing module, configured to input the source image and the template image into a target image fusion model, and fuse the source image and the template image through the target image fusion model, to obtain a target synthesized image; the target image fusion model being obtained by performing parameter adjustment on a second update model by using a third source image sample, a third template image sample, and a third standard synthesized image, a resolution of the third source image sample and the third template image sample being a fourth resolution, and a resolution of the third standard synthesized image being a fifth resolution; the second update model being obtained by inserting a second resolution update layer into a second parameter adjustment model; the second parameter adjustment model being obtained by performing parameter adjustment on a first update model by using a second source image sample, a second template image sample, and a second standard synthesized image, a resolution of the second source image sample and the second template image sample being a second resolution, and a resolution of the second standard synthesized image being a third resolution; the first update model being obtained by inserting a first resolution update layer into a first parameter adjustment model; and the first parameter adjustment model being obtained by performing parameter adjustment on an initial image fusion model by using a first source image sample, a first template image sample, and a first standard synthesized image, and a resolution of the first source image sample, the first template image sample, and the first standard synthesized image being a first resolution.

According to an aspect, embodiments of this application provide a computer device, including a processor, a memory, and an input/output interface;
the processor being separately connected to the memory and the input/output interface, the input/output interface being configured to receive data and output data, the memory being configured to store a computer program, and the processor being configured to invoke the computer program, to cause the computer device including the processor to perform the image processing method in embodiments of this application in an aspect.

According to an aspect, embodiments of this application provide a computer-readable medium, storing a computer program, the computer program being applicable to be loaded and executed by a processor, to cause a computer device having the processor to perform the image processing method in embodiments of this application in an aspect.

According to an aspect, embodiments of this application provide a computer program product or a computer program. The computer program product or the computer program includes computer instructions, and the computer instructions are stored in a computer-readable storage medium. A processor of a computer device reads the computer instructions from the computer-readable storage medium, and executes the computer instructions, to cause the computer device to perform the method provided in various implementations in embodiments of this application in an aspect. In other words, the computer instructions, when executed by the processor, implement the method provided in various implementations in embodiments of this application in an aspect.

Embodiments of this application that are implemented have the following beneficial effects:
In embodiments of this application, samples at the first resolution that are easily obtained in large quantities may be used for preliminary model training. Massive data of samples at the first resolution is used, which may ensure robustness and accuracy of the model. Further, progressive training is performed on an initially trained model through different resolutions, that is, using the sample at the second resolution and the sample at the fourth resolution, and the like, and progressive training is gradually performed on the initially trained model, to obtain a final model. The final model may be used to obtain the synthesized image at the fifth resolution, which may implement image enhancement. In addition, a small quantity of high-resolution samples are used to implement image enhancement, which may improve performance of the model while ensuring robustness of the model, thereby improving the clarity and the display effect of the fused image.

### BRIEF DESCRIPTION OF THE DRAWINGS

To describe the technical solutions in embodiments of this application or the related art more clearly, the following briefly describes the accompanying drawings required for describing the embodiments or the related art. Apparently, the accompanying drawings in the following description show merely some embodiments of this application, and a person of ordinary skill in the art may still derive other drawings from the accompanying drawings without creative efforts.

FIG. 1 is a diagram of a network interaction architecture of image processing according to an embodiment of this application.

FIG. 2 is a schematic diagram of a scenario of image processing according to an embodiment of this application.

FIG. 3 is a flowchart of a model training method of image processing according to an embodiment of this application.

FIG. 4a is a schematic diagram of a scenario of model training according to an embodiment of this application.

FIG. 4b is a schematic diagram of another scenario of model training according to an embodiment of this application.

FIG. 5 is a flowchart of an image processing method according to an embodiment of this application.

FIG. 6 is a schematic diagram of a scenario of image synthesizing according to an embodiment of this application.

FIG. 7 is a schematic diagram a scenario of video updating according to an embodiment of this application.

FIG. 8 is a schematic diagram of a model training apparatus according to an embodiment of this application.

FIG. 9 is a schematic diagram of an image processing apparatus according to an embodiment of this application.

FIG. 10 is a schematic diagram of a structure of a computer device according to an embodiment of this application.

### DESCRIPTION OF EMBODIMENTS

The technical solutions in embodiments of this application are clearly and completely described in the following with reference to the accompanying drawings in embodiments of this application. Apparently, the described embodiments are merely some rather than all of embodiments of this application. All other embodiments obtained by a person of ordinary skill in the art based on embodiments of this application without making creative efforts shall fall within the protection scope of this application.

In a case that object (such as a user, and the like) data needs to be collected in embodiments of this application, a prompt interface or a pop-up window is displayed before and during collection. The prompt interface or the pop-up window is configured for prompting a user that XXXX data is currently being collected. Only after obtaining a confirmation operation by the user on the prompt interface or the pop-up window, related steps of data collection start to be performed, otherwise a data collection process ends. The collected user data is used in a proper and legal scenario or purpose. In this embodiment, in some scenarios in which user data needs to be used but is not authorized by the user, authorization may be further requested from the user, and then the user data is used when the authorization is passed.

Embodiments of this application may relate to machine learning technology in the field of artificial intelligence (AI), and training and use of a model may be implemented through the machine learning technology.

For example, embodiments of this application describe training and use of a target region prediction model and a target media repair model. By perform training on the model, the model continuously learns new knowledge or skills, and then a trained model is obtained for data repair. For example, in embodiments of this application, a trained target image fusion model is obtained by learning techniques for fusion between images, so that the target image fusion model may fuse an object in one image into another image.

With the development of the AI technology, the AI technology is studied and applied in a plurality of fields such as a common smart home, a smart wearable device, a virtual assistant, a smart speaker, smart marketing, unmanned driving, automatic driving, an unmanned aerial vehicle, a robot, smart medical care, smart customer service, internet of vehicles, autonomous driving, smart transportation, and the like. The AI technology in the future will be applied to more fields, and play an increasingly important role.

Video face swapping in embodiments of this application refers to fusing features of a face in one image into another image. Definition of face swapping is to swap an input source image (source) to a face template (template) of a template image, and an output face result (result) (namely, a face in the fused image) maintains information such as an expression, an angle, a background, and the like of the face in the template image. In other words, when an overall shape of the face in the template image is maintained, related features of the face in the source image are fused into the template image, to maintain overall harmony and image authenticity of the fused image.

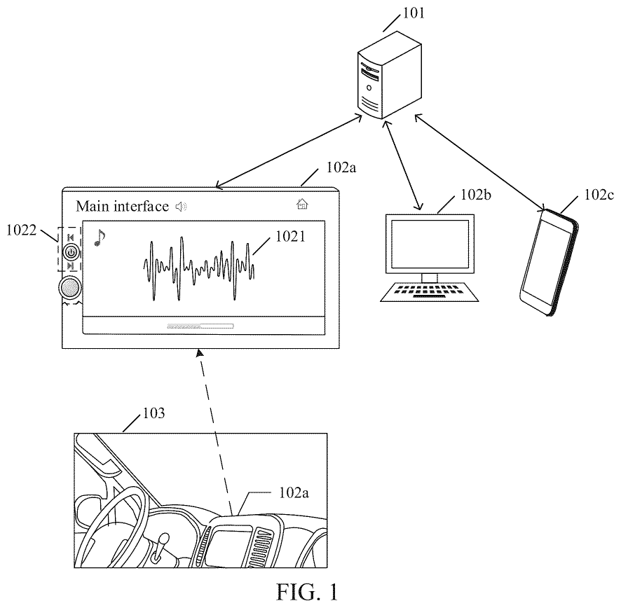

In embodiments of this application, FIG. 1 is a diagram of a network interaction architecture of image processing according to an embodiment of this application. A computer device 101 may perform data exchange with a terminal device, and different terminal devices may also perform data exchange with each other. A quantity of terminal devices may be one or at least two. For example, a quantity of terminal devices is three as shown in FIG. 1, including a terminal device 102a, a terminal device 102b, a terminal device 102c, and the like. In an embodiment, only a computer device 101 may exist. The computer device 101 may obtain a sample configured to perform model training from storage space of the computer device 101, may also obtain samples configured to perform model training from any one or more terminal devices, or may obtain a sample configured to perform model training from the internet, or may obtain samples configured to perform model training through a plurality of channels (that is, not limited to one channel, such as simultaneously obtain samples from the storage space of the computer device 101 and the internet), which are not limited herein. The computer device 101 may perform model training based on the obtained samples at different resolutions. Specifically, because a sample at a low resolution (such as a first resolution, and the like) is easier to obtain, and a cost of obtaining is lower. Therefore, a quantity of low-resolution samples is great, a sample at a high resolution (such as a fourth resolution, and the like) is not easy to obtain, and a cost of obtaining is high. Therefore, a quantity of high-resolution samples is less. In this way, a good compromise effect between a cost of model training and model performance may be achieved. The samples may be used to perform training on the model at resolutions in ascending order. First, a large quantity of low-resolution samples are used to implement preliminary training of the model, to ensure robustness and accuracy of the model. Then a small quantity of high-resolution samples are used to perform further training and adjustment on the initially trained model, to further improve performance of the model, thereby improving clarity and a display effect of the synthesized image implemented by the model. Further, based on the trained target image fusion model, features of an object in one image may be integrated into another image, to implement image fusion.

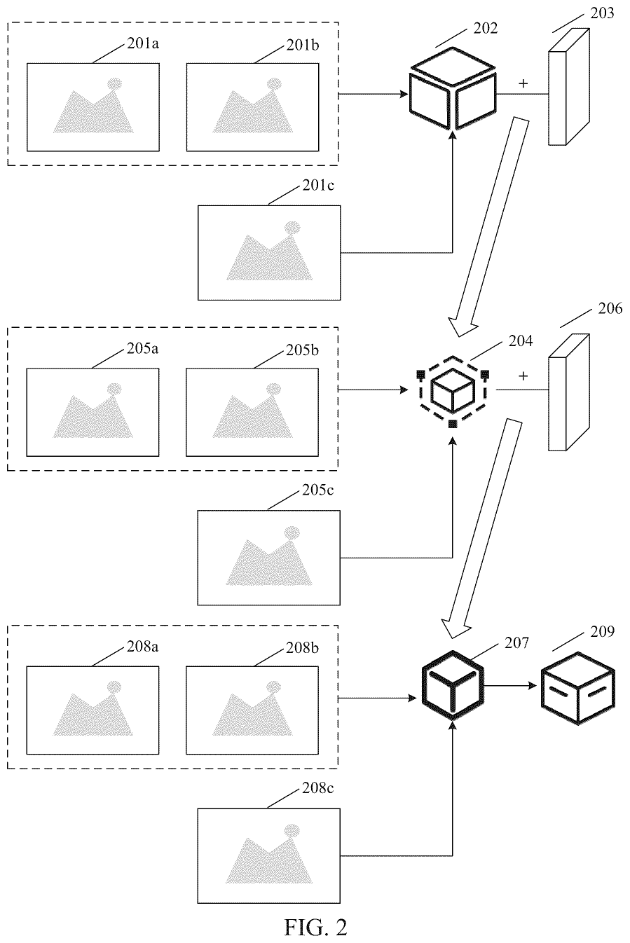

Specifically, FIG. 2 is a schematic diagram of a scenario of image processing according to an embodiment of this application. As shown in FIG. 2, a computer device may input a first source image sample 201a and a first template image sample 201b at a first resolution into an initial image fusion model 202. Parameter adjustment is performed on the initial image fusion model 202 in combination with a first standard synthesized image 201c at the first resolution, to obtain a first parameter adjustment model. A first resolution update layer 203 is inserted into the first parameter adjustment model, to obtain a first update model 204. Further, a second source image sample 205a and a second template image sample 205b at a second resolution are input into the first update model 204. Parameter adjustment is performed on the first update model 204 in combination with a second standard synthesized image 205c at a third resolution, to obtain a second parameter adjustment model. A second resolution update layer 206 is inserted into the second parameter adjustment model, to obtain a second update model 207 Further, a third source image sample 208a and a third template image sample 208b at a fourth resolution are input into the second update model 207. Parameter adjustment is performed on the second update model 207 in combination with a third standard synthesized image 208c at a fifth resolution, to obtain a target image fusion model 209. By gradually performing training on the model by using samples of different resolutions, a final model may be obtained. For example, initial training may be performed on the model by using enough low-resolution samples that are easily obtained, to ensure robustness and accuracy of the model. Then samples at higher resolutions are used to gradually perform further adjustment on the model, to improve performance and a processing effect of the model, thereby improving clarity and a display effect of the images implemented by the model.

The computer device mentioned in embodiments of this application includes but is not limited to a terminal device or a server. In other words, the computer device may be the server or the terminal device, or a system including the server and the terminal device. The terminal device mentioned above may be an electronic device, including but not limited to a mobile phone, a tablet personal computer, a desktop computer, a notebook computer, a palmtop computer, a vehicle-mounted device, an augmented reality/virtual reality (AR/VR) device, a helmet-mounted display, a smart television, a wearable device, a smart speaker, a digital camera, a camera, and other mobile internet devices (MID) with network access capabilities, or terminal devices in scenarios such as a train, a ship, a flight, and the like. As shown in FIG. 1, the terminal device may be a notebook computer (shown as the terminal device 102b), a mobile phone (shown as the terminal device 102c), or a vehicle-mounted device (shown as the terminal device 102a), and the like. FIG. 1 only illustrates a part of devices. In this embodiment, the terminal device 102a refers to a device located in a vehicle 103. The server mentioned above may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, vehicle-road collaboration, a content delivery network (CDN), big data, and an artificial intelligence platform.

The data involved in embodiments of this application may be stored in a computer device, or may be stored based on a cloud storage technology or a blockchain network, which is not limited herein.

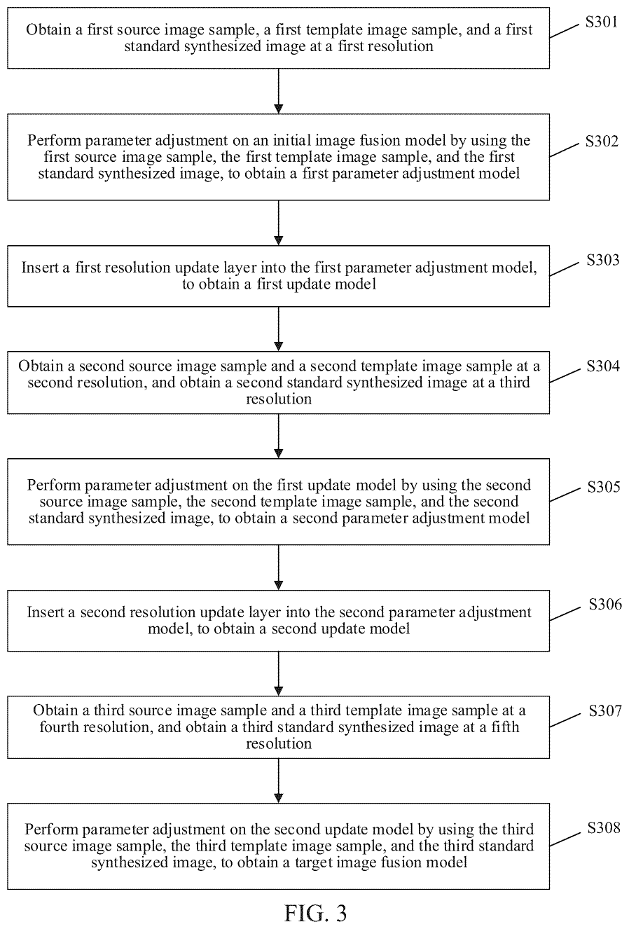

Further, FIG. 3 is a flowchart of a model training method of image processing according to an embodiment of this application. As shown in FIG. 3, a model training process of image processing is performed by a computer device, including the following steps S301 to S308.

Step S301: Obtain a first source image sample, a first template image sample, and a first standard synthesized image at a first resolution.

In embodiments of this application, the computer device may obtain the first source image sample at the first resolution, obtain the first template image sample at the first resolution, and obtain a first standard synthesized image corresponding to the first source image sample and the first template image sample at the first resolution. The first standard synthesized image refers to an image theoretically obtained by integrating a target sample object corresponding to a target object type in the first source image sample into the first template image sample. In this embodiment, the first source image sample and the first template image sample may be images including an image background, or may be images including only a target object region corresponding to the target object type. For example, when the first source image sample includes the image background, the model obtained by training the first source image sample, the first template image sample, and the first standard synthesized image may directly perform object fusion on the image including the image background, thereby improving simplicity and convenience of image fusion. In addition, using the entire image for model training may improve integrity and harmony of the predicted image of the model to a certain extent. For another example, when the first source image sample only includes the target object region, the model obtained by training in this way reduces interference of the image background on model training because there are no regions other than the target object region in the sample, and accuracy and precision of model training are improved to a certain extent.

For example, the computer device may obtain a first source input image and a first template input image. The first source input image is determined as the first source image sample, and the first template input image is determined as the first template image sample. Alternatively, target object detection may be performed on the first source input image, to obtain a target object region corresponding to a target object type in the first source input image, and cropping is performed on the target object region in the first source input image, to obtain the first source image sample at the first resolution, or object registration may be performed in the target object region, to obtain a sample object key point of the target sample object (namely, an object corresponding to the target object type), and the first source image sample at the first resolution is determined based on the sample object key point, and the like. Object registration is an image preprocessing technology, such as “face registration”, which may locate coordinates of key points of facial features. Input information of a face registration algorithm is a “face picture” and a “face coordinate frame”, and output information is a coordinate sequence of the key points of the facial features. A quantity of key points of the facial features is a preset fixed value, which may be defined according to different requirements. There are usually fixed values such as 5 points, 68 points, and 90 points. Detection is performed on the first template input image, to obtain a to-be-fused region corresponding to a target object type in the first template input image, and cropping is performed on the to-be-fused region in the first template input image, to obtain the first template image sample at the first resolution. Further, the first standard synthesized image of the first source image sample and the first template image sample at the first resolution may be obtained. The target object type may be but is not limited to a face type, an animal face type, or an object type (such as furniture or ornaments, and the like), and is not limited herein.

In this embodiment, the first resolution refers to a low resolution. For example, the first resolution may be a resolution of 256. With the development of technologies such as multimedia, clarity of multimedia data continues to improve, and resolutions of image samples that may be obtained for model training continue to increase. In this way, the first resolution may also be a resolution of 512 or a resolution of 1024, and the like. In other words, the first resolution is not a fixed value, but a value determined based on the development of resolution at that time. The first resolution may be considered as a low resolution relative to a high resolution. Corresponding to the low resolution, there are more images that may be used as samples for model training. For division of the high resolution and the low resolution, a resolution threshold may be set as required. In a case that a resolution is lower than the threshold, the resolution is the low resolution. Corresponding to the low resolution, there are more image samples available for model training. In a case that the resolution is higher than the threshold, the resolution is the high resolution. Corresponding to the high resolution, a quantity of image samples that may be used for model training is much lower than a quantity of image samples corresponding to the low resolution. The resolution of the first source image sample and the resolution of the first template image sample belong to a preset first resolution range, and the first resolution range includes the first resolution. In other words, when obtaining the first source image sample and the first template image sample at the first resolution, it is not necessary to obtain an image exactly at the first resolution. The first source image sample and the first template image sample may also be obtained in the first resolution range. For example, it is assumed that the first resolution is a resolution of 256, the resolution of the first source image sample may be a resolution of 250, and the like (that is, any resolution in the first resolution range). The resolution of the first template image sample may be a resolution of 258, and the like (that is, any resolution in the first resolution range), which is not limited herein.

Step S302: Perform parameter adjustment on an initial image fusion model by using the first source image sample, the first template image sample, and the first standard synthesized image, to obtain a first parameter adjustment model.

In embodiments of this application, the computer device may input the first source image sample and the first template image sample into the initial image fusion model and perform prediction, to obtain a first predicted synthesized image at the first resolution; and perform parameter adjustment on the initial image fusion model by using the first predicted synthesized image and the first standard synthesized image, to obtain the first parameter adjustment model.

When the first predicted synthesized image is obtained through prediction of the initial image fusion model, the computer device may input the first source image sample and the first template image sample into the initial image fusion model, and perform feature combination on the first source image sample and the first template image sample, to obtain a first sample combined feature. Specifically, the first source sample feature corresponding to the first source image sample may be obtained, and the first template sample feature corresponding to the first template image sample may be obtained. Feature fusion is performed on the first source sample feature and the first template sample feature, to obtain the first sample combined feature. The feature fusion may be feature splicing, and the like. For example, feature fusion may be performed on the first source sample feature and the first template sample feature based on the image channel, to obtain the first sample combined feature. Specifically, the first source sample feature and the feature of the same image channel in the first template sample feature may be spliced, to obtain the first sample combined feature. Certainly, the image channel may also be a grayscale channel, or image channels respectively corresponding to C (Cyan), M (Magenta), Y (Yellow), K (black), or three image channels of R (Red), G (Green), B (Blue), and the like, which are not limited herein. For example, it is assumed that the first source image sample corresponds to three image channels R, G, and B, the first template image sample corresponds to the three image channels R, G, and B, a first source sample feature dimension is 256*256*3, and a first template sample feature dimension is 256*256*3, then the first sample combined feature dimension may be 256*512*3 or 512*256*3, and the like. Channel splicing may be performed on the first source sample feature and the first template sample feature, to obtain the first sample combined feature. For example, under the three image channels of R, G, and B, when a first source sample feature dimension is 256*256*3, and a first template sample feature dimension is 256*256*3, the first sample combined feature dimension may be 256*256*6, and the like.

Further, encoding processing is performed on the first sample combined feature in the initial image fusion model, to obtain a first sample object update feature. For example, resolution adjustment processing may be performed on the first sample combined feature, and the first sample combined feature after resolution adjustment processing is performed is encoded into the first sample object update feature in a latent space. A first sample object recognition feature corresponding to a target object type in the first source image sample is identified, feature fusion on the first sample object recognition feature and the first sample object update feature is performed, and the first predicted synthesized image at the first resolution is predicted. The target object type refers to a type of a target object to be fused into the first template image sample. For example, when a solution of this application is used for face swapping, the target object type may be a face type. In a case that the solution of this application is used to generate a virtual image in a video, the target object type may be a virtual character type, and the like.

When feature fusion is performed between the first sample object recognition feature and the first sample object update feature, and the first predicted synthesized image at the first resolution is predicted, the computer device may obtain a first statistical parameter corresponding to the first sample object recognition feature, and obtain a second statistical parameter corresponding to the first sample object update feature; adjust the first sample object update feature by using the first statistical parameter and the second statistical parameter, to obtain a first initial sample fusion feature; and perform decoding processing on the first initial sample fusion feature, to obtain the first predicted synthesized image at the first resolution. Alternatively, feature adjustment is performed on the first sample object update feature through the first sample object recognition feature, to obtain the first initial sample fusion feature. For example, the first initial adjustment parameter in the initial image fusion model may be obtained, and the first initial adjustment parameter may be used to perform weight processing on the first sample object recognition feature, to obtain a to-be-added sample feature. Feature fusion is performed on the to-be-added sample feature and the first sample object update feature, to obtain the first initial sample fusion feature. The model obtained by training may include the first adjustment parameter after training with the first initial adjustment parameter. Alternatively, the second initial adjustment parameter in the initial image fusion model may be obtained, and the second initial adjustment parameter may be used to perform feature fusion on the first sample object update feature and the first sample object recognition feature, to obtain the first initial sample fusion feature. The model obtained by training may include the second adjustment parameter after training with the second initial adjustment parameter.

For example, an example of an obtaining process of the first initial sample fusion feature may be shown in formula \textcircled{1}:

$$Ad ( x , y ) = σ ( y ) ( \frac{x - μ ( x )}{σ ( x )} ) + μ ( y ) \qquad 1$$

As shown in formula \textcircled{1}, x is swap_features, and y is used to represent src_id_features. Swap_features is used to represent the first sample object update feature, src_id_features is used to represent the first sample object recognition feature, and Ad(x,y) is used to represent the first initial sample fusion feature. σ may represent an average value, μ may represent a standard deviation, and the like. Specifically, the first statistical parameter may include a first average value parameter σ(y), a first standard deviation parameter μ(y), and the like; and the second statistical parameter may include a second average value parameter σ(x), a second standard deviation parameter μ(x), and the like.

In this embodiment, the initial image fusion model may include a plurality of convolutional layers, and a quantity of convolutional layers is not limited herein. In this embodiment, the initial image fusion model may include an encoder and a decoder. The computer device may perform feature fusion on the first source image sample and the first template image sample through the encoder in the initial image fusion model, to obtain the first initial sample fusion feature. Decoding processing is performed on the first initial sample fusion feature by the decoder in the initial image fusion model, to obtain the first predicted synthesized image at the first resolution. The initial image fusion model is configured to output the image at the first resolution.

Further, when the first predicted synthesized image and the first standard synthesized image are used to perform parameter adjustment on the initial image fusion model, to obtain the first parameter adjustment model, the computer device may generate a loss function based on the first predicted synthesized image and the first standard synthesized image, and perform parameter adjustment on the initial image fusion model based on the loss function, to obtain the first parameter adjustment model. A quantity of loss functions may be m, and m is a positive integer. For example, when m is greater than 1, a total loss function may be generated according to m loss functions. Parameter adjustment is performed on the initial image fusion model through the total loss function, to obtain the first parameter adjustment model. A value of m is not limited herein.

Specifically, the following are examples of possible loss functions:
(1) The computer device may obtain a first predicted sample fusion feature corresponding to the first predicted synthesized image, and obtain a feature similarity between the first predicted sample fusion feature and the first sample object recognition feature. A first loss function is generated according to the feature similarity. In this embodiment, parameter adjustment may be performed on the initial image fusion model based on the first loss function, to obtain the first parameter adjustment model. For the first loss function, refer to formula \textcircled{2}:

Loss_id=1−cosine_sitralarity(f ake_id_features,src_id_features)

As shown in formula \textcircled{2}, Loss_id is used to represent a first loss function, and cosine_similarity is used to represent feature similarity. The fake_id_features is used to represent the first predicted sample fusion feature, and src_id_features is used to represent the first sample object recognition feature. Through the first loss function, the synthesized image generated by prediction may be made more similar to a target object that needs to be fused into a template image, thereby improving accuracy of image fusion. For example, when an object A in an image 1 is replaced with an object B, through the first loss function, an updated image of the image 1 may be made more similar to the object B, so that the updated image of the image 1 may better reflect features of the object B.

For a process of obtaining the feature similarity, refer to formula \textcircled{3}:

$$cosine\_similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad 3$$

As shown in formula \textcircled{3}, θ may be used to represent a vector angle between A and B, A is used to represent fake_id_features, and B is used to represent src_id_features. The fake_id_features is used to represent the first predicted sample fusion feature, and the src_id_features is used to represent the first sample object recognition feature. Aᵢ is used to represent each feature component in the first predicted sample fusion feature, and Bᵢ is used to represent each feature component in the first sample object recognition feature.

(2) For an example of the loss function, refer to formula \textcircled{4}. The loss function may be referred to as a second loss function:

Loss_Recons=|fake−gt_img| \textcircled{4}

As shown in formula \textcircled{4}, fake is used to represent the first predicted synthesized image, gt_img is used to represent the first standard synthesized image, and Loss_Recons is used to represent the second loss function. Specifically, the computer device may generate a second loss function according to a pixel difference value between the first predicted synthesized image and the first standard synthesized image.

(3) For an example of the loss function, refer to formula \textcircled{5}. The loss function may be referred to as a third loss function:

Loss_D=−log D(gt_img)−log(1−D(fake)) \textcircled{2}

As shown in formula \textcircled{5}, Loss_D is used to represent the third loss function, fake is used to represent the first predicted synthesized image, gt_img is used to represent the first standard synthesized image, and DO is used to represent an image discriminator. The image discriminator is used to determine whether the image sent to the network is a real image. Specifically, the computer device may perform image discrimination on the first standard synthesized image and the first predicted synthesized image through the image discriminator, and generate the third loss function based on a discrimination result.

(4) For an example of the loss function, refer to formula \textcircled{6}. The loss function may be referred to as a fourth loss function:

Loss_G=log(1−D(fake)) \textcircled{6}

As shown in formula 0, Loss_G is used to represent the fourth loss function, fake is used to represent the first predicted synthesized image, and DO is used to represent the image discriminator. Specifically, the computer device may perform image discrimination on the first predicted synthesized image through the image discriminator, and generate the fourth loss function based on a discrimination result. The fourth loss function may improve model performance, thereby improving authenticity of images predicted by the model.

Some of the loss functions listed above are not limited to the loss functions listed above in actual implementation.

In this embodiment, m loss functions may be any one of a plurality of loss functions or any plurality of loss functions that may be used. For example, the computer device may generate a second loss function according to a pixel difference value between the first predicted synthesized image and the first standard synthesized image; perform image discrimination on the first standard synthesized image and the first predicted synthesized image through an image discriminator, and generate a third loss function based on a discrimination result; perform image discrimination on the first predicted synthesized image through the image discriminator, and generate a fourth loss function based on a discrimination result; and perform parameter adjustment on the initial image fusion model by using the second loss function, the third loss function, and the fourth loss function, to obtain the first parameter adjustment model. For example, m loss functions may be the loss functions shown in (1) to (4), and the total loss function in this case may be recorded as loss=Loss_id+Loss_Recons+Loss_D+Loss_G. Through the foregoing process, preliminary adjustment training of the initial image fusion model is implemented. Because the first resolution is a relatively low resolution, there are a plurality of image samples that may be used for model training, robustness and accuracy of the trained model may be improved.

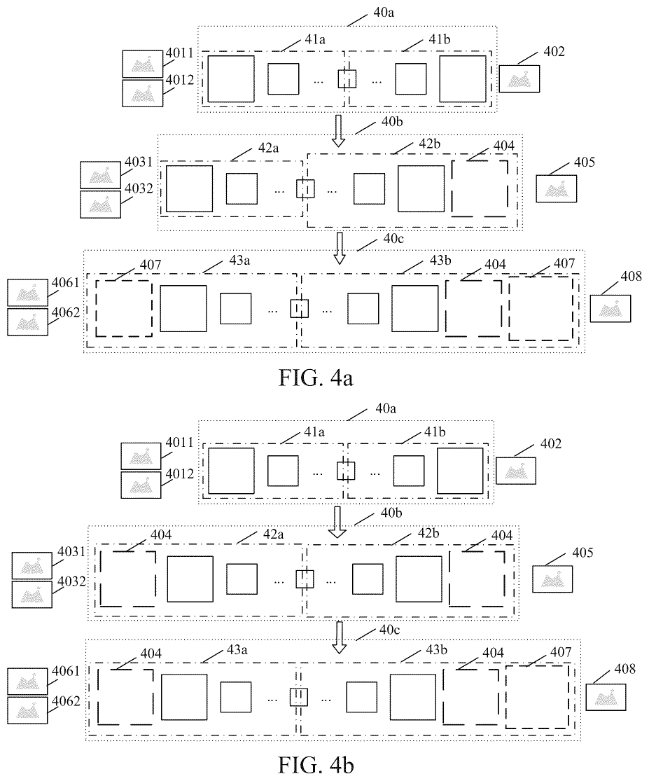

For example, refer to FIG. 4a or FIG. 4b. FIG. 4a is a schematic diagram of a scenario of model training according to an embodiment of this application. FIG. 4b is a schematic diagram of another scenario of model training according to an embodiment of this application. As shown in FIG. 4a or FIG. 4b, the computer device may input a first source image sample 4011 and a first template image sample 4012 at a first resolution into an initial image fusion model 40a, to obtain a first predicted synthesized image 402. Parameter adjustment is performed on the initial image fusion model 40a through the first predicted synthesized image 402 and a first standard synthesized image at the first resolution, to obtain a first parameter adjustment model. The initial image fusion model 40a may include an encoder 41a and a decoder 41b.

In other words, through step S301 and step S302 (which may be considered as a first training stage), a first parameter adjustment model at a lower resolution may be obtained. A resolution of an image that is output by prediction by the first parameter adjustment model is the first resolution, and the first parameter adjustment model is configured to fuse an object in one image into another image. For example, when this application is used in a face swapping scenario, the first parameter adjustment model may be considered as a face swapping model in the first training stage. Features of the face in one image (denoted as an image 1) may be fused into another image (denoted as an image 2), so that a face in the image 2 is replaced with a face in the image 1 without affecting integrity and coordination of the replaced image 2. In this case, a resolution of the image 2 after replacing the face obtained through the first parameter adjustment model is the first resolution.

Step S303: Insert a first resolution update layer into the first parameter adjustment model, to obtain a first update model.

In embodiments of this application, the computer device may insert the first resolution update layer into the first parameter adjustment model, to obtain the first update model. The first resolution update layer may be added as required. In other words, the first resolution update layer may include one or at least two convolutional layers. For example, the first resolution update layer may be a convolutional layer used to increase a decoding resolution, and used to output an image at a third resolution. The first resolution update layer may include a convolutional layer to be inserted into the decoder of the first parameter adjustment model, as shown in first resolution update layer 404 in FIG. 4a, namely, the convolutional layer shown by a long dotted line. A quantity of convolutional layers may be one or more. Alternatively, the first resolution update layer may include a convolutional layer used to improve a decoding resolution, that is, used to output the image at the third resolution, and may further include a convolutional layer used to process an image at a higher resolution, that is, used to process an image at a second resolution. In other words, the first resolution update layer may include the convolutional layer to be inserted into the decoder of the first parameter adjustment model, and may further include a convolutional layer to be inserted into the encoder of the first parameter adjustment model, as shown in the first resolution update layer 404 in FIG. 4b, namely, the convolutional layer shown by the long dotted line. In other words, a quantity of convolutional layers separately inserted in the encoder and decoder may be one or more. Specifically, the first resolution update layer 404 may be inserted into the first parameter adjustment model, to obtain a first update model 40b.

Step S304: Obtain a second source image sample and a second template image sample at a second resolution, and obtain a second standard synthesized image at a third resolution.

In embodiments of this application, the computer device may obtain the second source image sample and the second template image sample at the second resolution, and obtain the second standard synthesized image of the second source image sample and the second template image sample at the third resolution. For details, refer to the detailed description shown in step S301 in FIG. 3. Alternatively, the computer device may obtain the second source image sample, the second template image sample, and the second standard synthesized image according to the first source image sample, the first template image sample, and the first standard synthesized image. Specifically, when the second resolution is equal to the first resolution, the first source image sample is determined as the second source image sample at the second resolution, and the first template image sample is determined as the second template image sample at the second resolution; and resolution enhancement processing is performed on the first standard synthesized image, to obtain the second standard synthesized image at the third resolution. In this case, the first update model 40b shown in FIG. 4a may be used. Resolution enhancement processing is performed on the first source image sample when the second resolution is greater than the first resolution, to obtain the second source image sample at the second resolution; resolution enhancement processing is performed on the first template image sample, to obtain the second template image sample at the second resolution; and resolution enhancement processing is performed on the first standard synthesized image, to obtain the second standard synthesized image at the third resolution. In this case, the first update model 40b shown in FIG. 4b may be used. The second resolution is not a fixed value. The same as the first resolution, the second resolution is also a value determined based on the development of the resolution at that time. In other words, the resolution of the second source image sample and the resolution of the second template image sample belong to a preset second resolution range, and the second resolution range includes the second resolution.

The second resolution is greater than or equal to the first resolution, and the third resolution is greater than the first resolution. For example, when the first resolution is a resolution of 256, the second resolution may be the resolution of 256 or a resolution of 512, and the like, and the third resolution may be the resolution of 512; and when the first resolution is a resolution of 512, the second resolution may be the resolution of 512 or a resolution of 1024, and the like, and the third resolution may be the resolution of 1024, and the like.

Step S305: Perform parameter adjustment on the first update model by using the second source image sample, the second template image sample, and the second standard synthesized image, to obtain a second parameter adjustment model.

In embodiments of this application, the computer device may input the second source image sample and the second template image sample into the first update model and perform prediction, to obtain a second predicted synthesized image at the third resolution; and perform parameter adjustment on the first update model by using the second predicted synthesized image and the second standard synthesized image, to obtain the second parameter adjustment model. Specifically, for the process, refer to the detailed description shown in step S302 in FIG. 3. For example, the “first” resolution of the first source image sample and the first template image sample in step S302 may be replaced with the “second” resolution, the “first” resolution of the first standard synthesized image may be replaced with the “third” resolution, the “first” corresponding to other terms may be updated to the “second”, and the process shown in this step (namely, step S305) may be obtained. For example, the computer device may input the second source image sample and the second template image sample into the first update model, and perform feature combination on the second source image sample and the second template image sample, to obtain a second sample combined feature. Encoding processing is performed on the second sample combined feature in the first update model, to obtain a second sample object update feature; and a second sample object recognition feature corresponding to a target object type in the second source image sample is identified, feature fusion on the second sample object recognition feature and the second sample object update feature is performed, and the second predicted synthesized image at the third resolution is predicted. For a prediction process of the second predicted synthesized image, refer to the prediction process of the first predicted synthesized image shown in step S302.

Further, in a parameter adjustment manner, parameter adjustment may be performed on the first update model by using the second predicted synthesized image and the second standard synthesized image, to obtain the second parameter adjustment model.

Specifically, in a parameter adjustment manner, parameter adjustment may be performed on the first resolution update layer in the first update model by using the second predicted synthesized image and the second standard synthesized image, to obtain the second parameter adjustment model. In other words, in addition to the convolutional layer other than the first resolution update layer in the first update model, the parameter obtained by training in the previous steps may be reused. In other words, the parameter in the first parameter adjustment model may be reused, and only parameter adjustment is performed on the first resolution update layer in the first update model, thereby improving training efficiency of the model. This step may be implemented by using each formula shown in step S302.

In other words, the parameter adjustment process of the first update model in this step is different from the parameter adjustment process of the initial image fusion model in step S302. In other words, in this step only the parameter in the first resolution update layer is adjusted, and in step S302, all parameters included in the initial image fusion model are adjusted. Apart from this, other processes are the same. Therefore, for a specific implementation process in this step, refer to the implementation process in step S302.

For example, as shown in FIG. 4a or FIG. 4b, the computer device may input the second source image sample 4031 and the second template image sample 4032 at the second resolution into the first update model 40b, obtain the second predicted synthesized image 405 by prediction, and fix the parameter in the convolutional layer other than the first resolution update layer 404 in the first update model 40b, to reuse the parameter obtained by training in the first training stage (namely, step S301 to step S302). The parameter of the convolutional layer shown by the solid line in the model update manner shown in FIG. 4a, or the parameter of the convolutional layer shown by the solid line in the model update manner shown in FIG. 4b. Through the second predicted synthesized image 405 and the second standard synthesized image at the third resolution, parameter adjustment is performed on the first resolution update layer 404 in the first update model 40b, to obtain the second parameter adjustment model. The first update model 40b may include an encoder 42a and a decoder 42b.

In this embodiment, in a parameter adjustment manner, the computer device may use the second source image sample, the second template image sample, and the second standard synthesized image, to perform parameter adjustment on the first resolution update layer in the first update model, to obtain the first layer adjustment model. In other words, the parameter in the convolutional layer other than the first resolution update layer in the first update model is reused, and only parameter adjustment is performed on the first resolution update layer, to improve the resolution of the model, and improve training efficiency of the model. Further, parameter adjustment is performed on all parameters in the first layer adjustment model by using the second source image sample, the second template image sample, and the second standard synthesized image, to obtain a second parameter adjustment model. Through this step, fine-tuning may be performed on all parameters of the model in the second training stage (step S303 to step S305), to improve accuracy of the model. For the training process of the first layer adjustment model and the second parameter adjustment model, refer to the training process of the first parameter adjustment model in step S302.

In other words, through step S303 to step S305, a second parameter adjustment model that performs resolution enhancement on the model (namely, the first parameter adjustment model) obtained in the first training stage may be obtained. The resolution of the image that is output by prediction by the second parameter adjustment model is the third resolution. Using the face swapping scenario as an example, after the features of the face in the image 1 are fused into the image 2 through the second parameter adjustment model, the resolution of the image 2 obtained after face swapping is the third resolution.

Step S306: Insert a second resolution update layer into the second parameter adjustment model, to obtain a second update model.

In embodiments of this application, the computer device may insert the second resolution update layer into the second parameter adjustment model, to obtain the second update model. For details, refer to the detailed description shown in step S303 in FIG. 3. For example, as shown in FIG. 4a, the second resolution update layer may include a convolutional layer used to improve a decoding resolution, that is, used to output the image at the fifth resolution, and may further include a convolutional layer used to process an image at a higher resolution, that is, used to process an image at a fourth resolution. In other words, the second resolution update layer may include the convolutional layer to be inserted into the decoder of the second parameter adjustment model, and may further include a convolutional layer to be inserted into the encoder of the second parameter adjustment model, such as the convolutional layer shown by the short dashed line in FIG. 4a. As shown in FIG. 4b, the second resolution update layer may include a convolutional layer used to improve a decoding resolution. In other words, the second resolution update layer may include a convolutional layer to be inserted into the decoder of the second parameter adjustment model, such as the convolutional layer shown by the short dashed line in FIG. 4b. Specifically, a second resolution update layer 407 may be inserted into the first parameter adjustment model, to obtain a second update model 40c. Certainly, in this embodiment, regardless of the model training scenario shown in FIG. 4a or the model training scenario shown in FIG. 4b, the second resolution update layer may further include a convolutional layer used to process the image at the fifth resolution. In other words, the second resolution update layer may further include the convolutional layer to be inserted into the encoder of the second parameter adjustment model, which may be referred to as a candidate convolutional layer. In other words, the model that is finally obtained may include the candidate convolutional layer, or may not include the candidate convolutional layer. The candidate convolutional layer is used to directly perform processing on the image at the fifth resolution.

Step S307: Obtain a third source image sample and a third template image sample at a fourth resolution, and obtain a third standard synthesized image at a fifth resolution.

In embodiments of this application, the fourth resolution being greater than or equal to the third resolution, and the fifth resolution being greater than or equal to the fourth resolution. For details, refer to the detailed description shown in step S304 in FIG. 3. For example, when the third resolution is a resolution of 512, the fourth resolution may be the resolution of 512 or a resolution of 1024, and the like, and the fifth resolution may be the resolution of 1024; and when the third resolution is a resolution of 1024, the fourth resolution may be the resolution of 1024 or a resolution of 2048, and the fifth resolution may be the resolution of 2048, and the like.

Step S308: Perform parameter adjustment on the second update model by using the third source image sample, the third template image sample, and the third standard synthesized image, to obtain a target image fusion model.

In embodiments of this application, the computer device may input the third source image sample and the third template image sample into the second update model and perform prediction, to obtain a third predicted synthesized image at the fifth resolution. For details of a prediction process of the third predicted synthesized image, refer to the prediction process of the first predicted synthesized image shown in step S302 in FIG. 3.

Further, in a parameter adjustment manner, parameter adjustment may be performed on the second update model by using the third predicted synthesized image and the third standard synthesized image, to obtain the target image fusion model. For example, as shown in FIG. 4a or FIG. 4b, the third source image sample 4061 and the third template image sample 4062 may be input into the second update model 40c, and the third predicted synthesized image 408 may be obtained by prediction. Parameter adjustment is performed on the second update model 40c through the third predicted synthesized image 408 and the third standard synthesized image, to obtain the target image fusion model. For a parameter adjustment process of the target image fusion model, refer to the parameter adjustment process of the initial image fusion model shown in step S302.

Alternatively, in a parameter adjustment manner, parameter adjustment may be performed on the second resolution update layer in the second update model by using the third source image sample, the third template image sample, and the third standard synthesized image, to obtain a third parameter adjustment model. For details, refer to a training process of the first parameter adjustment model shown in step S302 in FIG. 3. In other words, in addition to the convolutional layer other than the second resolution update layer in the second update model, the parameter obtained by training in the previous steps may be reused. In other words, the parameter in the second parameter adjustment model may be reused, and only parameter adjustment is performed on the second resolution update layer in the second update model, thereby improving training efficiency of the model. Alternatively, parameter adjustment may be performed on the second resolution update layer in the second update model by using the third source image sample, the third template image sample, and the third standard synthesized image, to obtain a second layer parameter adjustment model; and parameter adjustment is performed on all parameters in the second layer adjustment model by using the third source image sample, the third template image sample, and the third standard synthesized image, to obtain a third parameter adjustment model. In other words, the parameter in the second parameter adjustment model is first reused, to save model training time, and then fine-tuning is performed on all parameters of the second layer adjustment model, to improve the accuracy of the model. Further, based on the third parameter adjustment model, a fourth source image sample and a fourth template image sample at the fifth resolution may be obtained, a fourth standard synthesized image of the fourth source image sample and the fourth template image sample at the fifth resolution may be obtained, and fine-tuning may be performed on the third parameter adjustment model by using the fourth source image sample, the fourth template image sample, and the fourth standard synthesized image, to obtain the target image fusion model. In this embodiment, when the second resolution update layer does not include a convolutional layer used to process the image at the fifth resolution, when adjusting the parameter of the third parameter adjustment model, the third resolution update layer may be inserted into the third parameter adjustment model, to obtain the third update model, and the fourth source image sample, the fourth template image sample, and the fourth standard synthesized image are used, to perform parameter adjustment on the third update model, to obtain the target image fusion model.

In each of the foregoing steps, for a prediction process of each predicted synthesized image, refer to the prediction process of the first predicted synthesized image shown in step S302 in FIG. 3. A parameter adjustment process of each model differs only in the adjusted parameters. For a specific implementation process, refer to the parameter adjustment process of the initial image fusion model in step S302.

The target image fusion model is configured to fuse an object in one image into another image.

In this embodiment, the computer device may obtain training samples separately corresponding to the three training stages, and determine an update manner of a quantity of layers of the model based on the training samples corresponding to the three training stages. Through the update manner of the quantity of layers of the model, the first resolution update layer and the subsequent second resolution update layer are determined. For example, when the training samples separately corresponding to the three training stages that are obtained include a training sample (including an input sample at a resolution of 256 and a predicted sample at a resolution of 256) at a resolution of 256 used in the first training stage, a training sample (including an input sample at a resolution of 256 and a predicted sample at a resolution of 512) at a resolution of 512 used in the second training stage, and a training sample (including an input sample at a resolution of 512 and a predicted sample at a resolution of 1024) at a resolution of 1024 used in the third training stage, the update manner of the quantity of layers of the model is to add a convolutional layer to the decoder of the model obtained in the first training stage, to obtain the model required for training in the second training stage. Convolutional layers are separately added to the encoder and decoder of the model obtained in the second training stage, to obtain the model required for training in the third training stage. In other words, the update manner of the quantity of layers of the model is used to indicate the convolutional layers included in the first resolution update layer and the second resolution update layer. Alternatively, the computer device may obtain the first update model in step S303, and determine the second resolution according to the first resolution update layer. For example, when the first resolution update layer includes a convolutional layer used to improve the decoding resolution, the second resolution is equal to the first resolution; and when the first resolution update layer includes a convolutional layer used to improve the decoding resolution and a convolutional layer used to process an image at a higher resolution, the second resolution is greater than the first resolution. The second update model may be obtained in step S306, and the fourth resolution may be determined according to the second resolution update layer.

The foregoing is a training process of the target image fusion model in embodiments of this application. The initial image fusion model is a model used to process the first source image and the first template image sample at the first resolution, and output the first predicted synthesized image at the first resolution. Through three training stages, including step S301 and step S302 (a first stage), step S303 to step S305 (a second stage), and step S306 to step S308 (a third stage), the target image fusion model that may be used to output the image at the fifth resolution is obtained by training. In this embodiment, the target image fusion model may include a convolutional layer used to directly perform encoding on the image at the fifth resolution. In another embodiment, the target image fusion model may also not include a convolutional layer used to perform encoding on the image at the fifth resolution, and when inputting the image at the fifth resolution, directly perform encoding processing on the input image at the fifth resolution by using adaptability of the model. For example, the first training stage is model training for the first resolution, that is, training a model that may output the image at the first resolution, such as a resolution of 256; the second training stage is model training for the third resolution, that is, training a model that may output the image at the third resolution, such as a resolution of 512; and the third training stage is model training for the fifth resolution, that is, training a model that may output the image at the fifth resolution, such as a resolution of 1024. Specifically, in actual implementation, a final effect of the model that needs to be achieved may be determined, that is, a target resolution that needs to be obtained by training, and the target resolution is determined as the fifth resolution. The first resolution and the third resolution are determined according to the fifth resolution. Further, the second resolution may be determined according to the third resolution, and the fourth resolution may be determined according to the fifth resolution. For example, it is assumed that it is determined that the target resolution is a resolution of 2048, it may be determined that the fifth resolution is the resolution of 2048. According to the fifth resolution, it is determined that the third resolution is a resolution of 1024, and it is determined that the first resolution is a resolution of 512. According to the fifth resolution, it is determined that the fourth resolution is the resolution of 2048 or the resolution of 1024. According to the third resolution, it is determined that the second resolution is the resolution of 1024 or the resolution of 512.

In embodiments of this application, samples at the first resolution that are easily obtained in large quantities may be used for preliminary model training Massive data of samples at the first resolution is used, which may ensure robustness and accuracy of the model. Further, progressive training is performed on an initially trained model through different resolutions, that is, using the sample at the second resolution and the sample at the fourth resolution, and the like, and progressive training is gradually performed on the initially trained model, to obtain a final model. The final model may be used to obtain the synthesized image at the fifth resolution, which may implement image enhancement. In addition, a small quantity of high-resolution samples are used to implement image enhancement, which may improve performance of the model while ensuring robustness of the model, thereby improving the clarity and the display effect of the fused image.

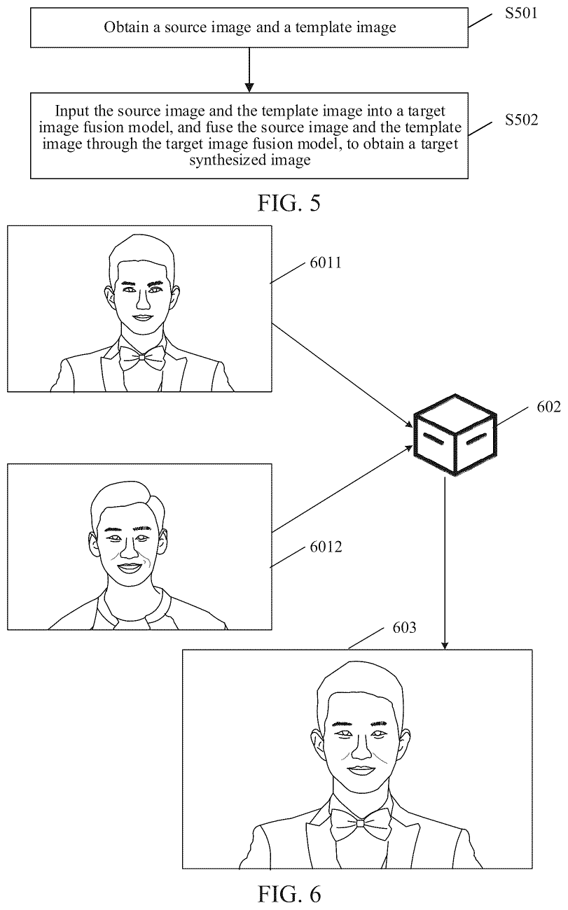

Further, FIG. 5 is a flowchart of an image processing method according to an embodiment of this application. As shown in FIG. 5, the image processing process includes the following steps.

Step S501: Obtain a source image and a template image.

In embodiments of this application, the computer device may obtain the source image and the template image. Alternatively, at least two video frame images that make up an original video may be obtained, the at least two video frame images are determined as template images, and the source image is obtained. In this case, a quantity of template images is at least two.

In embodiments of this application, the computer device may obtain a first input image and a second input image, detect the first input image, to obtain a to-be-fused region corresponding to a target object type in the first input image, and crop the to-be-fused region in the first input image, to obtain the template image; and perform target object detection on the second input image, to obtain a target object region corresponding to a target object type in the second input image, and crop the target object region in the second input image, to obtain the source image.

Step S502: Input the source image and the template image into a target image fusion model, and fuse the source image and the template image through the target image fusion model, to obtain a target synthesized image.

In embodiments of this application, the target image fusion model being obtained by performing parameter adjustment on a second update model by using a third source image sample, a third template image sample, and a third standard synthesized image, a resolution of the third source image sample and the third template image sample being a fourth resolution, and a resolution of the third standard synthesized image being a fifth resolution; the second update model being obtained by inserting a second resolution update layer into a second parameter adjustment model; the second parameter adjustment model being obtained by performing parameter adjustment on a first update model by using a second source image sample, a second template image sample, and a second standard synthesized image, a resolution of the second source image sample and the second template image sample being a second resolution, and a resolution of the second standard synthesized image being a third resolution; the first update model being obtained by inserting a first resolution update layer into a first parameter adjustment model; and the first parameter adjustment model being obtained by performing parameter adjustment on an initial image fusion model by using a first source image sample, a first template image sample, and a first standard synthesized image, and a resolution of the first source image sample, the first template image sample, and the first standard synthesized image being a first resolution.

Specifically, feature combination is performed on the source image and the template image in the target image fusion model, to obtain a combined feature; encoding processing is performed on the combined feature, to obtain an object update feature, and an object recognition feature corresponding to a target object type in the source image is identified; and feature fusion is performed between the object recognition feature and the object update feature, and the target synthesized image is predicted. For details, refer to a generation process of the first predicted synthesized image shown in step S302 in FIG. 3. Specifically, when feature fusion is performed between the object recognition feature and the object update feature, and the target synthesized image is predicted, the computer device may obtain an recognition statistical parameter corresponding to the object recognition feature, and obtain an update statistical parameter corresponding to the object update feature; adjustment is performed on the object update feature by using the recognition statistical parameter and the update statistical parameter, to obtain an initial fusion feature; and decoding processing is performed on the initial fusion feature, to obtain the target synthesized image. Alternatively, feature adjustment may be performed on the object update feature through the object recognition feature, to obtain the initial fusion feature. For example, the first adjustment parameter in the target image fusion model may be obtained, and the first adjustment parameter may be used to perform weight processing on the object recognition feature, to obtain a to-be-added feature. Feature fusion is performed on the to-be-added feature and the object update feature, to obtain the initial fusion feature; or the second adjustment parameter in the target image fusion model may be obtained, and the second adjustment parameter may be used to perform feature fusion on the object update feature and the object recognition feature, to obtain the initial fusion feature. Further, decoding processing is performed on the initial fusion feature, to obtain the target synthesized image.

In this embodiment, when the template image is obtained by cropping, the target synthesized image may be replaced with content of a to-be-fused region in the template image, to obtain a target update image corresponding to the template image.

In this embodiment, when a quantity of source images is at least two, the target synthesized image includes target synthesized images respectively corresponding to the at least two source images, and at least two target synthesized images are combined, to obtain an object update video corresponding to the original video; and when the target update images corresponding to the at least two source images are obtained, at least two target update images are combined, to obtain an object update video corresponding to the original video.

The computer device configured to perform training on the target image fusion model and the computer device configured to process the image by using the target image fusion model may be the same device, or may be different devices.

For example, using a face swapping scenario as an example, FIG. 6 is a schematic diagram of a scenario of image synthesizing according to an embodiment of this application. As shown in FIG. 6, the computer device may obtain a template image 6011 and a source image 6012, and input the template image 6011 and the source image 6012 into a target image fusion model 602 for prediction, to obtain a target synthesized image 603. Certainly, the target synthesized image 603 shown in FIG. 6 is a simple image for illustration. For a specific display effect of the target synthesized image, refer to an actual operating result of the target image fusion model 602.

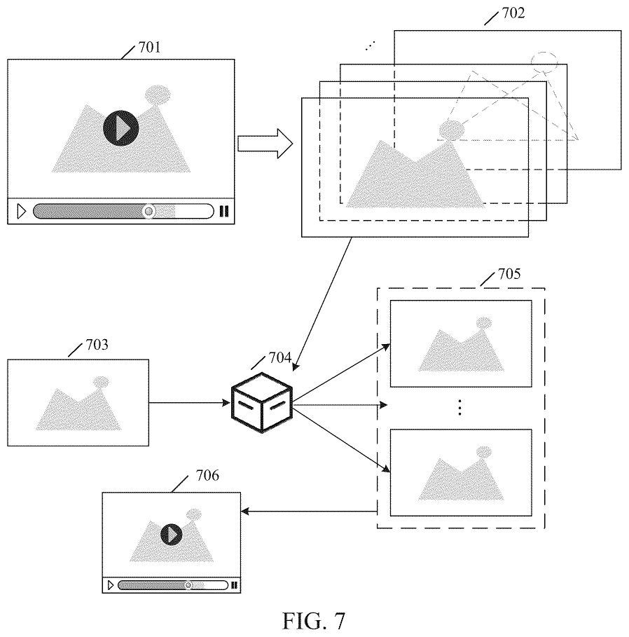

For example, in a scenario, FIG. 7 is a schematic diagram a scenario of video updating according to an embodiment of this application. As shown in FIG. 7, the computer device may perform split processing on an original video 701, to obtain at least two video frame images 702. The at least two video frame images 702 and a source image 703 are sequentially input into a target image fusion model 704 for prediction, to obtain target synthesized images 705 respectively corresponding to the at least two video frame images 702. At least two target synthesized images 705 are combined, to obtain an object update video 706 corresponding to the original video 701.

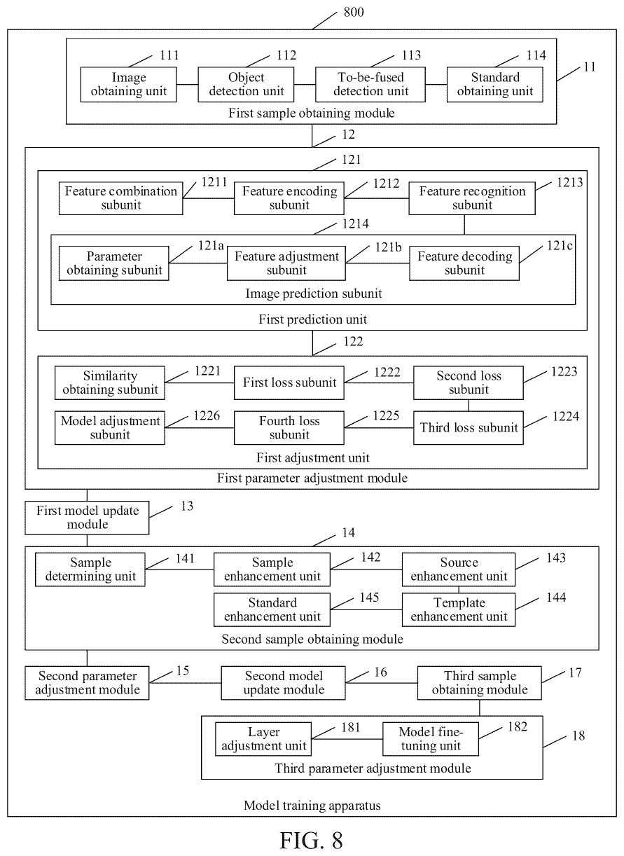

Further, FIG. 8 is a schematic diagram of a model training apparatus according to an embodiment of this application. The model training apparatus may be a computer program (including program code) run in a computer device. For example, the model training apparatus may be an application software, or may be a hardware component in a computer device, or may be an independent device; and the apparatus may be configured to perform corresponding steps in the methods provided in embodiments of this application. As shown in FIG. 8, the model training apparatus 800 may run in the computer device in the embodiment corresponding to FIG. 3. Specifically, the apparatus may include: a first sample obtaining module 11, a first parameter adjustment module 12, a first model update module 13, a second sample obtaining module 14, a second parameter adjustment module 15, a second model update module 16, a third sample obtaining module 17, and a third parameter adjustment module 18.

The first sample obtaining module 11 is configured to obtain a first source image sample, a first template image sample, and a first standard synthesized image at a first resolution;
the first parameter adjustment module 12 is configured to perform parameter adjustment on an initial image fusion model by using the first source image sample, the first template image sample, and the first standard synthesized image, to obtain a first parameter adjustment model;
the first model update module 13 is configured to insert a first resolution update layer into the first parameter adjustment model, to obtain a first update model;
the second sample obtaining module 14 is configured to obtain a second source image sample and a second template image sample at a second resolution, and obtain a second standard synthesized image at a third resolution;
the second parameter adjustment module 15 is configured to perform parameter adjustment on the first update model by using the second source image sample, the second template image sample, and the second standard synthesized image, to obtain a second parameter adjustment model; the second resolution being greater than or equal to the first resolution, and the third resolution being greater than the first resolution;
the second model update module 16 is configured to insert a second resolution update layer into the second parameter adjustment model, to obtain a second update model;
the third sample obtaining module 17 is configured to obtain a third source image sample and a third template image sample at a fourth resolution, and obtain a third standard synthesized image at a fifth resolution; and
the third parameter adjustment module 18 is configured to perform parameter adjustment on the second update model by using the third source image sample, the third template image sample, and the third standard synthesized image, to obtain a target image fusion model; the target image fusion model being configured to fuse an object in one image into another image; and the fourth resolution being greater than or equal to the third resolution, and the fifth resolution being greater than or equal to the fourth resolution.

The first parameter adjustment module 12 includes:
a first prediction unit 121, configured to input the first source image sample and the first template image sample into the initial image fusion model and perform prediction, to obtain a first predicted synthesized image at the first resolution; and
a first adjustment unit 122, configured to perform parameter adjustment on the initial image fusion model by using the first predicted synthesized image and the first standard synthesized image, to obtain the first parameter adjustment model.

The first prediction unit 121 includes:
a feature combination subunit 1211, configured to input the first source image sample and the first template image sample into the initial image fusion model, and perform feature combination on the first source image sample and the first template image sample, to obtain a first sample combined feature;
a feature encoding subunit 1212, configured to perform encoding processing on the first sample combined feature in the initial image fusion model, to obtain a first sample object update feature;
a feature recognition subunit 1213, configured to recognize a first sample object recognition feature corresponding to a target object type in the first source image sample; and
an image prediction subunit 1214, configured to perform feature fusion on the first sample object recognition feature and the first sample object update feature, and predict the first predicted synthesized image at the first resolution.

The image prediction subunit 1214 includes:
a parameter obtaining subunit 121a, configured to obtain a first statistical parameter corresponding to the first sample object recognition feature, and obtain a second statistical parameter corresponding to the first sample object update feature;
a feature adjustment subunit 121b, configured to adjust the first sample object update feature by using the first statistical parameter and the second statistical parameter, to obtain a first initial sample fusion feature; and
a feature decoding subunit 121c, configured to perform decoding processing on the first initial sample fusion feature, to obtain the first predicted synthesized image at the first resolution.

The first adjustment unit 122 includes:
a similarity obtaining subunit 1221, configured to obtain a first predicted sample fusion feature corresponding to the first predicted synthesized image, and obtain a feature similarity between the first predicted sample fusion feature and the first sample object recognition feature; and
a first loss subunit 1222, configured to generate a first loss function according to the feature similarity, and performing parameter adjustment on the initial image fusion model based on the first loss function, to obtain the first parameter adjustment model.

The first adjustment unit 122 includes:
a second loss subunit 1223, configured to generate a second loss function according to a pixel difference value between the first predicted synthesized image and the first standard synthesized image;
a third loss subunit 1224, configured to perform image discrimination on the first standard synthesized image and the first predicted synthesized image through an image discriminator, and generate a third loss function based on a discrimination result;
a fourth loss subunit 1225, configured to perform image discrimination on the first predicted synthesized image through the image discriminator, and generate a fourth loss function based on a discrimination result; and
a model adjustment subunit 1226, configured to perform parameter adjustment on the initial image fusion model by using the second loss function, the third loss function, and the fourth loss function, to obtain the first parameter adjustment model.

The second sample obtaining module 14 includes:
a sample determining unit 141, configured to, when the second resolution is equal to the first resolution, determine the first source image sample as the second source image sample at the second resolution, and determine the first template image sample as the second template image sample at the second resolution; and
a sample enhancement unit 142, configured to perform resolution enhancement processing on the first standard synthesized image, to obtain the second standard synthesized image at the third resolution.

The second sample obtaining module 14 includes:
a source enhancement unit 143, configured to perform resolution enhancement processing on the first source image sample when the second resolution is greater than the first resolution, to obtain the second source image sample at the second resolution;
a template enhancement unit 144, configured to perform resolution enhancement processing on the first template image sample, to obtain the second template image sample at the second resolution; and
a standard enhancement unit 145, configured to perform resolution enhancement processing on the first standard synthesized image, to obtain the second standard synthesized image at the third resolution.

The third parameter adjustment module 18 includes:
a layer adjustment unit 181, configured to perform parameter adjustment on the second resolution update layer in the second update model by using the third source image sample, the third template image sample, and the third standard synthesized image, to obtain a third parameter adjustment model; and
a model fine-tuning unit 182, configured to obtain a fourth source image sample and a fourth template image sample at the fifth resolution, obtain a fourth standard synthesized image of the fourth source image sample and the fourth template image sample at the fifth resolution, and perform fine-tuning on the third parameter adjustment model by using the fourth source image sample, the fourth template image sample, and the fourth standard synthesized image, to obtain the target image fusion model.

The first sample obtaining module 11 includes:
an image obtaining unit 111, configured to obtain a first source input image and a first template input image;
an object detection unit 112, configured to perform target object detection on the first source input image, to obtain a target object region corresponding to a target object type in the first source input image, and crop the target object region in the first source input image, to obtain the first source image sample at the first resolution;
a to-be-fused detection unit 113, configured to detect the first template input image, to obtain a to-be-fused region corresponding to a target object type in the first template input image, and perform crop the to-be-fused region in the first template input image, to obtain the first template image sample at the first resolution; and
a standard obtaining unit 114, configured to obtain the first standard synthesized image of the first source image sample and the first template image sample at the first resolution.

The model training apparatus provided in embodiments of this application is used, and samples at the first resolution that are easily obtained in large quantities may be used for preliminary model training. Massive data of samples at the first resolution is used, which may ensure robustness and accuracy of the model. Further, progressive training is performed on an initially trained model through different resolutions, that is, using the sample at the second resolution and the sample at the fourth resolution, and the like, and progressive training is gradually performed on the initially trained model, to obtain a final model. The final model may be used to obtain the synthesized image at the fifth resolution, which may implement image enhancement. In addition, a small quantity of high-resolution samples are used to implement image enhancement, which may improve performance of the model while ensuring robustness of the model, thereby improving the clarity and the display effect of the fused image.

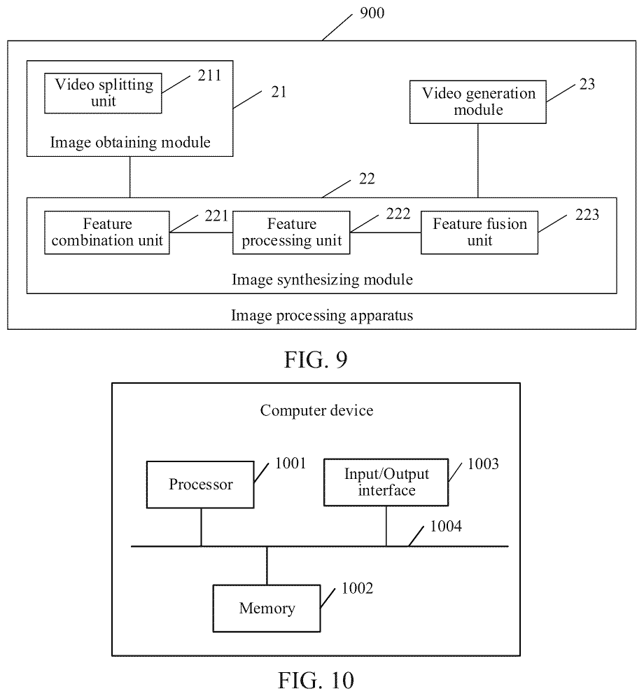

Further, FIG. 9 is a schematic diagram of an image processing apparatus according to an embodiment of this application. The image processing apparatus may be a computer program (including program code) run in a computer device. For example, the image processing apparatus may be an application software, or may be a hardware component in a computer device, or may be an independent device; and the apparatus may be configured to perform corresponding steps in the methods provided in embodiments of this application. As shown in FIG. 9, the image processing apparatus 900 may run in the computer device in the embodiment corresponding to FIG. 5. Specifically, the apparatus may include: an image obtaining module 21 and an image synthesizing module 22.

The image obtaining module 21 is configured to obtain a source image and a template image; and
the image synthesizing module 22 is configured to input the source image and the template image into a target image fusion model, and fuse the source image and the template image through the target image fusion model, to obtain a target synthesized image. The target image fusion model being obtained by performing parameter adjustment on a second update model by using a third source image sample, a third template image sample, and a third standard synthesized image, a resolution of the third source image sample and the third template image sample being a fourth resolution, and a resolution of the third standard synthesized image being a fifth resolution; the second update model being obtained by inserting a second resolution update layer into a second parameter adjustment model; the second parameter adjustment model being obtained by performing parameter adjustment on a first update model by using a second source image sample, a second template image sample, and a second standard synthesized image, a resolution of the second source image sample and the second template image sample being a second resolution, and a resolution of the second standard synthesized image being a third resolution; the first update model being obtained by inserting a first resolution update layer into a first parameter adjustment model; and the first parameter adjustment model being obtained by performing parameter adjustment on an initial image fusion model by using a first source image sample, a first template image sample, and a first standard synthesized image, and a resolution of the first source image sample, the first template image sample, and the first standard synthesized image being a first resolution.

The image obtaining module 21 includes:
a video splitting unit 211, configured to obtain at least two video frame images that make up an original video, determine the at least two video frame images as template images, and obtain the source image, where a quantity of template images is at least two, and the target synthesized image includes target synthesized images respectively corresponding to the at least two template images; and
the apparatus 900 further includes:
a video generation module 23, configured to combine at least two target synthesized images, to obtain an object update video corresponding to the original video.

The image synthesizing module 22 includes:
a feature combination unit 221, configured to input the source image and the template image into a target image fusion model, and perform feature combination on the source image and the template image in the target image fusion model, to obtain a combined feature;
a feature processing unit 222, configured to perform encoding processing on the combined feature, to obtain an object update feature, and recognize an object recognition feature corresponding to a target object type in the source image; and
a feature fusion unit 223, configured to perform feature fusion on the object recognition feature and the object update feature, and predict the target synthesized image.

FIG. 10 is a schematic diagram of a structure of a computer device according to an embodiment of this application. As shown in FIG. 10, the computer device in embodiments of this application may include: one or more processors 1001, a memory 1002, and an input/output interface 1003. The processor 1001, the memory 1002, and the input/output interface 1003 are connected by using a communication bus 1004. The memory 1002 is configured to store a computer program. The computer program includes program instructions. The input/output interface 1003 is configured to receive data and output data, such as configured to perform data exchange between the computer device and the terminal device, or configured to perform data exchange between various convolutional layers in the model; and the processor 1001 is configured to execute the program instructions stored in the memory 1002, to perform a model training method of image processing shown in FIG. 3 or the image processing method shown in FIG. 5.

In some implementations, the processor 1001 may be a central processing unit (CPU), and may be further another general-purpose processor, a digital signal processor (DSP), an application specific integrated circuit (ASIC), a field-programmable gate array (FPGA), or another programmable logic device, a discrete gate or a transistor logic device, a discrete hardware component, or the like. The general purpose processor may be a microprocessor. Alternatively, the processor may also be any conventional processor, or the like.

The memory 1002 may include a read-only memory and a random access memory, and provide an instruction and data to the processor 1001 and the input/output interface 1003. A part of the memory 1002 may further include a non-volatile random access memory. For example, the memory 1002 may further store information of a device type.

In a specific implementation, the foregoing computer device may perform the implementations provided in various steps in FIG. 3 or FIG. 5 through built-in functional modules of the computer. For details, refer to FIG. 3 or FIG. 5. Details are not described herein again.

In embodiments of this application, a computer-readable storage medium is further provided, storing a computer program. The computer program is applicable to be loaded and executed by a processor, to implement the image processing method provided in various steps in FIG. 3 or FIG. 5. For details, refer to FIG. 3 or FIG. 5. Details are not described herein again. For technical details that are not disclosed in the embodiments of the computer-readable storage medium of this application, refer to the method embodiments of this application. In an example, the computer program may be deployed to be executed on a computer device, or deployed to be executed on a plurality of computer devices at the same location, or deployed to be executed on a plurality of computer devices that are distributed in a plurality of locations and interconnected by using a communication network.

The computer-readable storage medium may be the image processing apparatus provided in any of the foregoing embodiments or an internal storage unit of the computer device, for example, a hard disk or an internal memory of the computer device. The computer-readable storage medium may also be an external storage device of the computer device, such as a plug-in hard disk, a smart media card (SMC), a secure digital (SD) card, or a flash card that is equipped on the computer device. Further, the computer-readable storage medium may further include an internal storage unit of the computer device and an external storage device. The computer-readable storage medium is configured to store the computer program and another program and data that are required by the computer device. The computer-readable storage medium may be further configured to temporarily store data that has been outputted or data to be outputted.

Embodiments of this application further provide a computer program product or a computer program. The computer program product or the computer program includes computer instructions, the computer instructions being stored in a computer-readable storage medium. A processor of a computer device reads the computer instructions from the computer-readable storage medium and executes the computer instructions, to cause the computer device to perform the method provided in the various implementations in FIG. 3 or FIG. 6.

In embodiments of this application, claims, and accompanying drawings of this application, the terms “first” and “second” are intended to distinguish between different objects but do not indicate a particular order. In addition, the term “include” and any variant thereof are intended to cover a non-exclusive inclusion. For example, a process, method, apparatus, product, or device that includes a series of steps or modules is not limited to the listed steps or modules; and instead, further includes a step or module that is not listed, or further includes another step or unit that is intrinsic to the process, method, apparatus, product, or device.

A person of ordinary skill in the art may be aware that the units and algorithm steps in the examples described with reference to the embodiments disclosed herein may be implemented by electronic hardware, computer software, or a combination thereof. To clearly describe the interchangeability between the hardware and the software, the foregoing has generally described compositions and steps of each example according to functions. Whether the functions are executed in a mode of hardware or software depends on particular applications and design constraint conditions of the technical solutions. A person skilled in the art may use different methods to implement the described functions of each particular application, but it does not be considered that the implementation goes beyond the scope of this application.

The methods and related apparatuses provided by the embodiments of this application are described with reference to the method flowcharts and/or schematic structural diagrams provided in the embodiments of this application. Specifically, each process of the method flowcharts and/or each block of the schematic structural diagrams, and a combination of processes in the flowcharts and/or blocks in the block diagrams can be implemented by computer program instructions. These computer program instructions may be provided for a general-purpose computer, a dedicated computer, an embedded processor, or a processor of any other programmable image processing device to generate a machine, so that the instructions executed by a computer or a processor of any other programmable image processing device generate an apparatus for implementing a specific function in one or more processes in the flowcharts and/or in one or more blocks in the schematic structural diagrams. These computer program instructions may also be stored in a computer-readable memory that can guide a computer or another programmable image processing device to work in a specified manner, so that the instructions stored in the computer-readable memory generate a product including an instruction apparatus, where the instruction apparatus implements functions specified in one or more processes in the flowcharts and/or one or more blocks in the schematic structural diagrams. The computer program instructions may also be loaded onto a computer or another programmable image processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the schematic structural diagrams.

A sequence of the steps of the method in the embodiments of this application may be adjusted, and certain steps may also be combined or removed according to an actual requirement.

In this application, the term “unit” or “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. The units and/or modules in the apparatus in the embodiments of this application may be combined, divided, and deleted according to an actual requirement.

What are disclosed above are merely examples of embodiments of this application, and certainly are not intended to limit the protection scope of this application. Therefore, equivalent variations made in accordance with the claims of this application shall fall within the scope of this application.

What is claimed is:

1. A method for generating an image processing model performed by a computer device, the method comprising:
performing parameter adjustment on an initial image fusion model by using a first source image sample, a first template image sample, and a first standard synthesized image to obtain a first parameter adjustment model, and inserting a first resolution update layer into the first parameter adjustment model, to obtain a first update model;
performing parameter adjustment on the first update model by using a second source image sample and a second template image sample, and a second standard synthesized image, to obtain a second parameter adjustment model;
inserting a second resolution update layer into the second parameter adjustment model, to obtain a second update model; and
performing parameter adjustment on the second update model by using a third source image sample and a third template image sample, and a third standard synthesized image, to obtain a target image fusion model configured to fuse an object in one image into another image.

2. The method according to claim 1, wherein the performing parameter adjustment on the second update model by using a third source image sample and a third template image sample, and a third standard synthesized image, to obtain a target image fusion model configured to fuse an object in one image into another image comprises:
inputting the first source image sample and the first template image sample into the initial image fusion model to obtain a first predicted synthesized image; and
performing parameter adjustment on the initial image fusion model by using the first predicted synthesized image and the first standard synthesized image, to obtain the first parameter adjustment model.

3. The method according to claim 1, wherein the first source image sample, the first template image sample, and the first standard synthesized image all have a first resolution, and the second source image sample and the second template image sample both have a second resolution, and the method further comprises:
when the second resolution is equal to the first resolution, determining the first source image sample as the second source image sample at the second resolution, and determining the first template image sample as the second template image sample at the second resolution; and
performing resolution enhancement processing on the first standard synthesized image, to obtain the second standard synthesized image at a third resolution greater than the first resolution.

4. The method according to claim 1, wherein the first source image sample, the first template image sample, and the first standard synthesized image all have a first resolution, and the second source image sample and the second template image sample both have a second resolution, and the method further comprises:
performing resolution enhancement processing on the first source image sample when the second resolution is greater than the first resolution, to obtain the second source image sample at the second resolution;
performing resolution enhancement processing on the first template image sample, to obtain the second template image sample at the second resolution; and
performing resolution enhancement processing on the first standard synthesized image, to obtain the second standard synthesized image at a third resolution greater than the first resolution.

5. The method according to claim 1, wherein the performing parameter adjustment on the second update model by using a third source image sample and a third template image sample, and a third standard synthesized image, to obtain a target image fusion model comprises:
performing parameter adjustment on the second resolution update layer in the second update model by using the third source image sample, the third template image sample, and the third standard synthesized image, to obtain a third parameter adjustment model; and
performing fine-tuning on the third parameter adjustment model by using a fourth source image sample, a fourth template image sample, and a fourth standard synthesized image, to obtain the target image fusion model.

6. The method according to claim 5, wherein the third source image sample and the third template image sample both have a fourth resolution, and the third standard synthesized image, the fourth source image sample, the fourth template image sample, and the fourth standard synthesized image all have a fifth resolution that is greater than or equal to the fourth resolution.

7. The method according to claim 1, wherein the first standard synthesized image is generated by:
obtaining a first source input image and a first template input image;
performing target object detection on the first source input image, to obtain a target object region corresponding to a target object type in the first source input image, and cropping the target object region in the first source input image, to obtain the first source image sample at a first resolution;
detecting the first template input image, to obtain a to-be-fused region corresponding to a target object type in the first template input image, and cropping the to-be-fused region in the first template input image, to obtain the first template image sample at the first resolution; and
obtaining the first standard synthesized image of the first source image sample and the first template image sample at the first resolution.

8. A computer device, comprising a processor, a memory, and an input/output interface;
the processor being separately connected to the memory and the input/output interface, the input/output interface being configured to receive data and output data, the memory being configured to store a computer program, and the processor being configured to invoke the computer program, to cause the computer device to perform a method for generating an image processing model including:
performing parameter adjustment on an initial image fusion model by using a first source image sample, a first template image sample, and a first standard synthesized image to obtain a first parameter adjustment model, and inserting a first resolution update layer into the first parameter adjustment model, to obtain a first update model;
performing parameter adjustment on the first update model by using a second source image sample and a second template image sample, and a second standard synthesized image, to obtain a second parameter adjustment model;
inserting a second resolution update layer into the second parameter adjustment model, to obtain a second update model; and
performing parameter adjustment on the second update model by using a third source image sample and a third template image sample, and a third standard synthesized image, to obtain a target image fusion model configured to fuse an object in one image into another image.

9. The computer device according to claim 8, wherein the performing parameter adjustment on the second update model by using a third source image sample and a third template image sample, and a third standard synthesized image, to obtain a target image fusion model configured to fuse an object in one image into another image comprises:
inputting the first source image sample and the first template image sample into the initial image fusion model to obtain a first predicted synthesized image; and
performing parameter adjustment on the initial image fusion model by using the first predicted synthesized image and the first standard synthesized image, to obtain the first parameter adjustment model.

10. The computer device according to claim 8, wherein the first source image sample, the first template image sample, and the first standard synthesized image all have a first resolution, and the second source image sample and the second template image sample both have a second resolution, and the method further comprises:
when the second resolution is equal to the first resolution, determining the first source image sample as the second source image sample at the second resolution, and determining the first template image sample as the second template image sample at the second resolution; and
performing resolution enhancement processing on the first standard synthesized image, to obtain the second standard synthesized image at a third resolution greater than the first resolution.

11. The computer device according to claim 8, wherein the first source image sample, the first template image sample, and the first standard synthesized image all have a first resolution, and the second source image sample and the second template image sample both have a second resolution, and the method further comprises:
performing resolution enhancement processing on the first source image sample when the second resolution is greater than the first resolution, to obtain the second source image sample at the second resolution;
performing resolution enhancement processing on the first template image sample, to obtain the second template image sample at the second resolution; and
performing resolution enhancement processing on the first standard synthesized image, to obtain the second standard synthesized image at a third resolution greater than the first resolution.

12. The computer device according to claim 8, wherein the performing parameter adjustment on the second update model by using a third source image sample and a third template image sample, and a third standard synthesized image, to obtain a target image fusion model comprises:
performing parameter adjustment on the second resolution update layer in the second update model by using the third source image sample, the third template image sample, and the third standard synthesized image, to obtain a third parameter adjustment model; and
performing fine-tuning on the third parameter adjustment model by using a fourth source image sample, a fourth template image sample, and a fourth standard synthesized image, to obtain the target image fusion model.

13. The computer device according to claim 12, wherein the third source image sample and the third template image sample both have a fourth resolution, and the third standard synthesized image, the fourth source image sample, the fourth template image sample, and the fourth standard synthesized image all have a fifth resolution that is greater than or equal to the fourth resolution.

14. The computer device according to claim 8, wherein the first standard synthesized image is generated by:
obtaining a first source input image and a first template input image;
performing target object detection on the first source input image, to obtain a target object region corresponding to a target object type in the first source input image, and cropping the target object region in the first source input image, to obtain the first source image sample at a first resolution;
detecting the first template input image, to obtain a to-be-fused region corresponding to a target object type in the first template input image, and cropping the to-be-fused region in the first template input image, to obtain the first template image sample at the first resolution; and
obtaining the first standard synthesized image of the first source image sample and the first template image sample at the first resolution.

15. A non-transitory computer-readable storage medium, storing a computer program, the computer program, applicable to be loaded and executed by a processor of a computer device, causing the computer device to perform a method for generating an image processing model including:
performing parameter adjustment on an initial image fusion model by using a first source image sample, a first template image sample, and a first standard synthesized image to obtain a first parameter adjustment model, and inserting a first resolution update layer into the first parameter adjustment model, to obtain a first update model;
performing parameter adjustment on the first update model by using a second source image sample and a second template image sample, and a second standard synthesized image, to obtain a second parameter adjustment model;
inserting a second resolution update layer into the second parameter adjustment model, to obtain a second update model; and
performing parameter adjustment on the second update model by using a third source image sample and a third template image sample, and a third standard synthesized image, to obtain a target image fusion model configured to fuse an object in one image into another image.

16. The non-transitory computer-readable storage medium according to claim 15, wherein the performing parameter adjustment on the second update model by using a third source image sample and a third template image sample, and a third standard synthesized image, to obtain a target image fusion model configured to fuse an object in one image into another image comprises:
inputting the first source image sample and the first template image sample into the initial image fusion model to obtain a first predicted synthesized image; and
performing parameter adjustment on the initial image fusion model by using the first predicted synthesized image and the first standard synthesized image, to obtain the first parameter adjustment model.

17. The non-transitory computer-readable storage medium according to claim 15, wherein the first source image sample, the first template image sample, and the first standard synthesized image all have a first resolution, and the second source image sample and the second template image sample both have a second resolution, and the method further comprises:
when the second resolution is equal to the first resolution, determining the first source image sample as the second source image sample at the second resolution, and determining the first template image sample as the second template image sample at the second resolution; and
performing resolution enhancement processing on the first standard synthesized image, to obtain the second standard synthesized image at a third resolution greater than the first resolution.

18. The non-transitory computer-readable storage medium according to claim 15, wherein the first source image sample, the first template image sample, and the first standard synthesized image all have a first resolution, and the second source image sample and the second template image sample both have a second resolution, and the method further comprises:
performing resolution enhancement processing on the first source image sample when the second resolution is greater than the first resolution, to obtain the second source image sample at the second resolution;
performing resolution enhancement processing on the first template image sample, to obtain the second template image sample at the second resolution; and
performing resolution enhancement processing on the first standard synthesized image, to obtain the second standard synthesized image at a third resolution greater than the first resolution.

19. The non-transitory computer-readable storage medium according to claim 15, wherein the performing parameter adjustment on the second update model by using a third source image sample and a third template image sample, and a third standard synthesized image, to obtain a target image fusion model comprises:
performing parameter adjustment on the second resolution update layer in the second update model by using the third source image sample, the third template image sample, and the third standard synthesized image, to obtain a third parameter adjustment model; and
performing fine-tuning on the third parameter adjustment model by using a fourth source image sample, a fourth template image sample, and a fourth standard synthesized image, to obtain the target image fusion model.

20. The non-transitory computer-readable storage medium according to claim 15, wherein the first standard synthesized image is generated by:
obtaining a first source input image and a first template input image;
performing target object detection on the first source input image, to obtain a target object region corresponding to a target object type in the first source input image, and cropping the target object region in the first source input image, to obtain the first source image sample at a first resolution;
detecting the first template input image, to obtain a to-be-fused region corresponding to a target object type in the first template input image, and cropping the to-be-fused region in the first template input image, to obtain the first template image sample at the first resolution; and
obtaining the first standard synthesized image of the first source image sample and the first template image sample at the first resolution.
